(19) United States
(12) Patent Application Publication
(10) Pub. No.: US 2026/0245888 A1
(43) Pub. Date: Aug. 20, 2026

(54) CATHODE LAYER, LITHIUM-ION BATTERY, AND METHOD FOR MANUFACTURING CATHODE LAYER

(71) Applicant: TOYOTA JIDOSHA KABUSHIKI KAISHA, Toyota-shi (JP)

(72) Inventors: Ryosuke OHSAWA, Okazaki-shi (JP); Yuji MAHARA, Seto-shi (JP)

(73) Assignee: TOYOTA JIDOSHA KABUSHIKI KAISHA, Toyota-shi (JP)

(21) Appl. No.: 19/392,939

(22) Filed: Nov. 18, 2025

(30) Foreign Application Priority Data
Feb. 17, 2025 (JP) 2025-023655

(51) Int. Cl. H01M 4/525; C01G 53/50; H01M 10/0525

(52) U.S. Cl. CPC H01M 4/525; C01G 53/50; H01M 10/0525; C01P 2004/03; C01P 2004/54; C01P 2006/40

(57) ABSTRACT

A cathode layer for use in a lithium-ion battery includes, as a cathode active material, single-crystal active materials that are crystalline primary particles containing Li, a transition metal, and O. Each single-crystal active material includes long and short edges. The angle between the long and short edges is 60° or more and 120° or less. The aspect ratio, namely the ratio of the length of the long edge to the length of the short edge, is 1.2 or more. The long edge of each single-crystal active material extends along the (003) plane. The proportion N_{B}/N_{A} is 20% or more, where N_{A} represents the number of the single-crystal active materials, and N_{B} represents the number of the single-crystal active materials in which the direction of the long edge is inclined at an angle of 50° or more and 90° or less with respect to an in-plane direction of the cathode layer.

### CROSS-REFERENCE TO RELATED APPLICATION

This application claims priority to Japanese Patent Application No. 2025-023655 filed on Feb. 17, 2025. The disclosure of the above-identified application, including the specification, drawings, and claims, is incorporated by reference herein in its entirety.

### BACKGROUND

### 1. Technical Field

The present disclosure relates to cathode layers for lithium-ion batteries, lithium-ion batteries, and methods for manufacturing a cathode layer.

### 2. Description of Related Art

Battery development has been active in recent years. For example, in the automotive industry, batteries for use in battery electric vehicles (BEVs), plug-in hybrid electric vehicles (PHEVs), and hybrid electric vehicles (HEVs) have been actively developed. Active materials containing transition metals such as Ni, Co, and Mn are known as cathode active materials for use in batteries.

Techniques have also been proposed for aligning active-material particles in a specific orientation (for example, Japanese Unexamined Patent Application Publication Nos. 2020-87597 (JP 2020-87597 A), 2012-156129 (JP 2012-156129 A), and 2012-99405 (JP 2012-99405 A)).

### SUMMARY

There is a demand for higher-performance batteries. The present disclosure has been made in view of the above circumstances, and a primary object thereof is to provide a cathode layer for a lithium-ion battery that exhibits excellent rate capability. In the present disclosure, the term “rate capability” refers to a characteristic expressed as the ratio of the discharge capacity obtained when the battery is discharged at a high discharge current (high rate) to the discharge capacity obtained when the battery is discharged at a low discharge current (low rate), that is, the high-rate capacity retention. The higher this ratio is (which means the battery capacity is less likely to decrease even at high rates), the more preferable it is.

(1) A cathode layer for use in a lithium-ion battery, the cathode layer including, as a cathode active material, single-crystal active materials that are primary particles, the primary particles being crystalline and containing Li, a transition metal, and o, wherein
in a cross-sectional scanning electron microscope image of the cathode layer, each of the single-crystal active materials includes a long edge and a short edge, the angle between the long edge and the short edge is 600 or more and 120° or less, and the aspect ratio, defined as the ratio of the length of the long edge to the length of the short edge, is 1.2 or more,
the long edge of each of the single-crystal active materials extends along a (003) plane, and the proportion N_{B}/N_{A} is 20% or more, where N_{A} represents the number of the single-crystal active materials, and N_{B} represents the number of the single-crystal active materials in which the direction of the long edge is inclined at an angle of 50° or more and 90° or less with respect to an in-plane direction of the cathode layer.

(2) The cathode layer according to (1), wherein the length of the long edge of each of the single-crystal active materials is 0.5 μm or more.

(3) The cathode layer according to (1) or (2), wherein the proportion N_{B}/N_{A} is 28% or more and 50% or less.

(4) The cathode layer according to any one of (1) to (3), wherein the primary particles have a composition represented by LiₓNiₐCo_{b}Mn_{c}O_{y} (where 0.1≤x≤1.5, 0.5≤a≤1.0, 0≤b≤0.3, 0<c<0.3, a+b+c=1.0, and 1.5≤y≤2.1).

(5) A lithium-ion battery including the cathode layer according to any one of (1) to (4).
(6) A method for manufacturing the cathode layer according to any one of (1) to (4), the method including:
obtaining a cathode layer precursor by applying a cathode slurry containing the cathode active material including the single-crystal active materials; and orienting the single-crystal active materials such that the direction of the long edge of each of the single-crystal active materials is inclined at an angle of 50° or more and 90° or less with respect to the in-plane direction of the cathode layer, by exposing the cathode layer precursor to a magnetic field.

The present disclosure can provide a cathode layer for a lithium-ion battery that exhibits excellent rate capability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a cross-sectional scanning electron microscope image of a cathode layer of the present disclosure;

FIG. 2 is an enlarged view of a single-crystal active material P in the dotted frame in FIG. 1;

FIG. 3 schematically shows the crystal structure of a single-crystal active material P in the cathode layer of the present disclosure;

FIG. 4 schematically illustrates an orientation step in a method for manufacturing a cathode layer according to the present disclosure; and

FIG. 5 is a schematic sectional view illustrating a lithium-ion battery of the present disclosure.

### DETAILED DESCRIPTION OF EMBODIMENTS

Hereinafter, the present disclosure will be described in detail with reference to the drawings. The figures shown are provided for illustration, and the sizes and shapes of the individual parts may be exaggerated for ease of understanding.

### A. Cathode Layer

The cathode layer of the present disclosure is a cathode layer for use in a lithium-ion battery. The cathode layer includes, as a cathode active material, single-crystal active materials that are crystalline primary particles containing Li, a transition metal, and 0. In a cross-sectional scanning electron microscope image of the cathode layer, each of the single-crystal active materials includes a long edge and a short edge, the angle between the long edge and the short edge is 600 or more and 120° or less, and the aspect ratio, defined as the ratio of the length of the long edge to the length of the short edge, is 1.2 or more; the long edge of each of the single-crystal active materials extends along the (003) plane; and the proportion N_{B}/N_{A} is 20% or more, where N_{A} represents the number of the single-crystal active materials, and N_{B} represents the number of the single-crystal active materials in which the direction of the long edge is inclined at an angle of 50° or more and 90° or less with respect to an in-plane direction of the cathode layer.

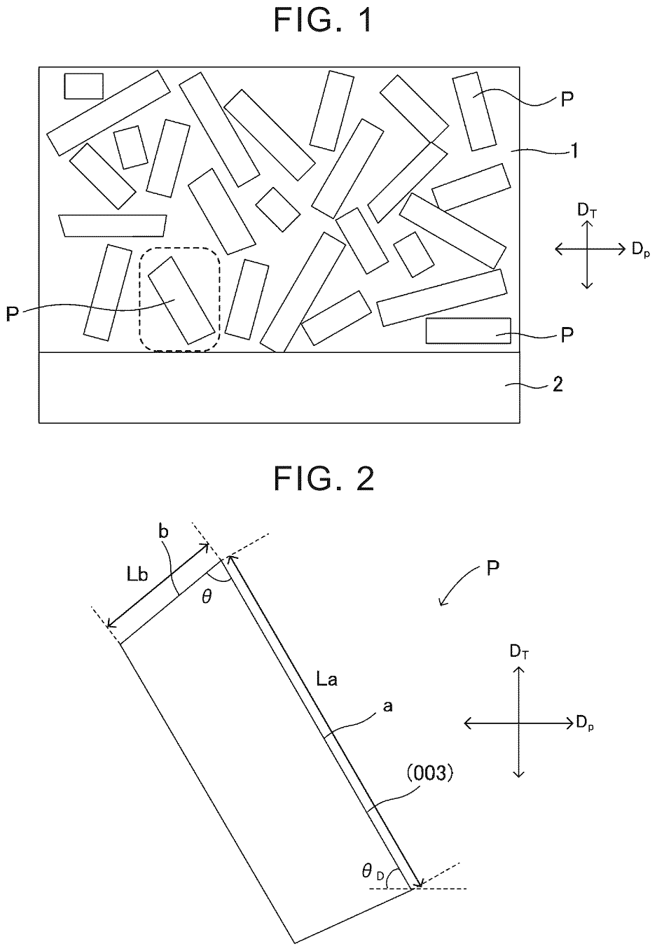

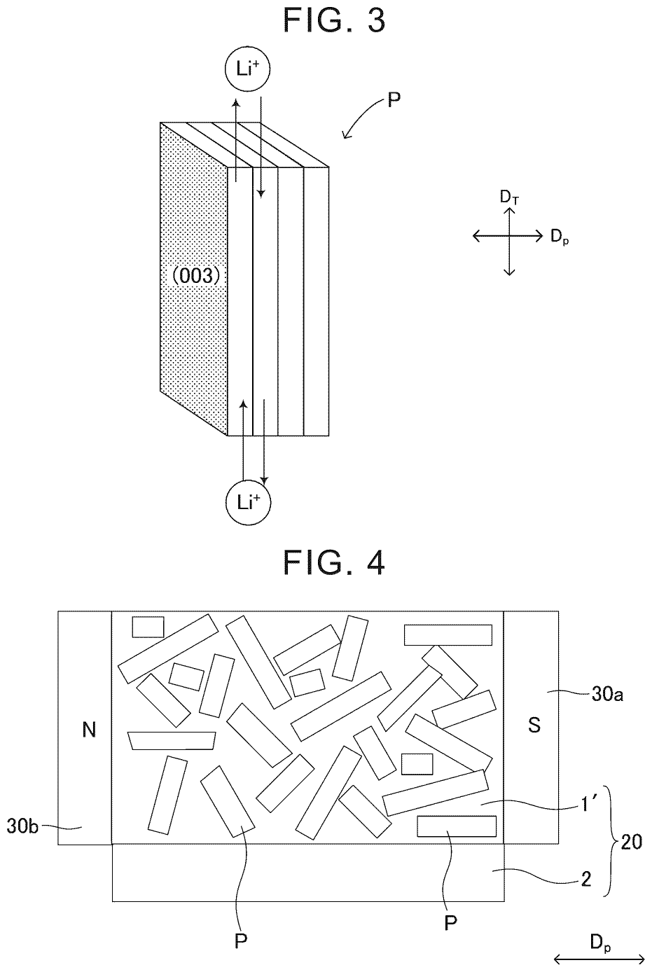

FIG. 1 schematically shows a cross-sectional scanning electron microscope image (hereinafter also referred to as “cross-sectional SEM image”) of the cathode layer of the present disclosure. FIG. 2 is an enlarged view of a single-crystal active material P in the dotted frame in FIG. 1. FIG. 3 schematically shows the crystal structure of a single-crystal active material P in the cathode layer of the present disclosure. As shown in FIG. 1, a cathode layer 1 of the present disclosure includes, as a cathode active material, the single-crystal active materials P that are crystalline primary particles containing Li, a transition metal, and 0. As shown in FIG. 2, in the cross-sectional SEM image of the cathode layer 1, each single-crystal active material P includes a long edge a and a short edge b, the angle θ between the long edge a and the short edge b is 600 or more and 1200 or less, and the aspect ratio, defined as the ratio of the length of the long edge a to the length of the short edge b, is 1.2 or more. In the present disclosure, the long edge a of each single-crystal active material P extends along the (003) plane. As shown in FIG. 3, the (003) plane is a crystal plane through which lithium ions do not enter or exit.

As described above, there is a demand for cathode layers for lithium-ion batteries that exhibit excellent rate capability. In the present disclosure, as shown in FIGS. 1 to 3, the single-crystal active materials P are orientated such that their long edges a are inclined substantially perpendicularly (i.e., at an angle of 500 or more and 900 or less) to the in-plane direction D_{P} of the cathode layer 1. In this way, the direction in which lithium ions move toward the cathode active material within the cathode layer 1 (the thickness direction D_{T} of the cathode layer 1) can be made substantially the same as the direction in which lithium ions diffuse within each single-crystal active material P. As a result, diffusion pathways for lithium ions can be efficiently secured, and the rate capability is improved. While JP 2020-87597 A discloses that active-material particles each having a core particle and a shell layer are oriented, the present disclosure differs in that the longitudinal direction of each single-crystal active material is directly aligned. In addition, JP 2020-87597 A does not describe securing efficient diffusion pathways for lithium ions.

In the present specification, a cross-sectional SEM image of the cathode layer may be obtained by, for example, exposing a cross section of the cathode layer using an ion milling device and then observing the cross section with a scanning electron microscope. The magnification of the cross-sectional SEM image may be, for example, 2,000× or more and 20,000× or less. As the scanning electron microscope, “SU8230,” a scanning electron microscope (SEM) manufactured by Hitachi High-Tech Corporation, may be used. Various dimensional measurements and shape analyses of the cross-sectional SEM image may be carried out using, for example, image analysis software such as “ImageJ.”

The cathode layer will now be described in detail.

### 1. Cathode Active Material

### (1) Cathode Active Material

The cathode layer of the present disclosure includes a cathode active material. The cathode active material includes single-crystal active materials that are crystalline primary particles containing Li, a transition metal, and O. In a cross-sectional scanning electron microscope image of the cathode layer, each of the single-crystal active materials includes a long edge and a short edge, the angle between the long edge and the short edge is 60° or more and 120° or less, and the aspect ratio, defined as the ratio of the length of the long edge to the length of the short edge, is 1.2 or more; the long edge of each of the single-crystal active materials extends along the (003) plane; and the proportion N_{B}/N_{A} is 20% or more, where N_{A} represents the number of the single-crystal active materials, and N_{B} represents the number of the single-crystal active materials in which the direction of the long edge is inclined at an angle of 50° or more and 90° or less with respect to the in-plane direction of the cathode layer.

The term “single-crystal active material” refers to an active material that is not a so-called polycrystalline active material (an active material that is a dense aggregate of numerous primary particles). A single-crystal active material typically does not aggregate and exists as an independent particle. It is preferable that no grain boundaries be observed in a single-crystal active material in SEM observation (at a magnification of about 10,000× to about 30,000×).

A single-crystal active material exhibits less degradation over time than a polycrystalline active material. A polycrystalline active material, which is a secondary particle, is prone to cracking, thereby easily exposing newly formed internal surfaces. The newly formed surfaces come into contact with the electrolyte solution and react with it, generating resistive components. The cathode layer of the present disclosure includes, as a cathode active material, single-crystal active materials. A single-crystal active material is less susceptible to stress and more resistant to cracking than a polycrystalline active material, and thus can suppress an increase in resistance associated with charging and discharging compared to a polycrystalline active material.

In the present disclosure, the primary particles contain Li, a transition metal, and O. The primary particles may contain one transition metal, two transition metals, three transition metals, or four or more transition metals.

Transition metals are metals belonging to Groups 3 to 11 of the periodic table. The transition metal contained in the primary particles may be a metal belonging to the third, fourth, or fifth period. Examples of transition metals include Ti, V, Cr, Mn, Fe, Co, Ni, Zr, Nb, La, and W.

It is preferable that the primary particles contain at least Ni as a transition metal, because this makes it possible to obtain a cathode active material with excellent capacity characteristics. The molar ratio of Ni to the transition metals (the total transition metals contained in the primary particles) is, for example, 0.25 or more, and may be 0.33 or more, 0.50 or more, 0.70 or more, or 0.80 or more. Increasing the proportion of Ni improves the capacity characteristics.

It is preferable that the primary particles contain either or both of Co and Mn as transition metals.

The primary particles may contain Co as a transition metal, or may not contain Co. The molar ratio of Co to the transition metals (the total transition metals contained in the primary particles) is, for example, 0 or more, and may be 0.05 or more, or 0.10 or more. The molar ratio of Co to the transition metals is, for example, 0.40 or less, and may be 0.20 or less.

The primary particles may contain Mn as a transition metal, or may not contain Mn. The molar ratio of Mn to the transition metals (the total transition metals contained in the primary particles) is, for example, 0 or more, and may be 0.05 or more, or 0.10 or more. The molar ratio of Mn to the transition metals is, for example, 0.40 or less, and may be 0.20 or less.

It is preferable that the primary particles contain at least one of the following elements as transition metals: Ni, Co, and Mn. The molar ratio of the total of Ni, Co, and Mn to the transition metals (the total transition metals contained in the primary particles) is, for example, 0.80 or more, and may be 0.90 or more, or 0.95 or more. The “total of Ni, Co, and Mn” also includes cases where the proportion of one or two elements selected from Ni, Co, and Mn is zero.

In addition to Li and transition metals, the primary particles may further contain another metal M¹ (including a metalloid) other than Li and the transition metals. Examples of the metal M¹ include metals belonging to Groups 12 to 14 of the periodic table. Examples of metals belonging to Groups 12 to 14 include Zn, Al, Si, Ga, Ge, In, and Sn.

The composition of the primary particles is not particularly limited, but may be represented by, for example, the general formula LiₓNiₐCo_{b}Mn_{c}O_{y} (where 0.1≤x≤1.5, 0.5≤a≤1.0, 0≤b≤0.3, 0≤c≤0.3, a+b+c=1.0, and 1.5≤y≤2.1).

In the above formula, x represents the molar ratio of Li to the total of Ni, Co, and Mn. Typically, x is 0.1 or more, and may be 0.4 or more, 0.6 or more, 0.8 or more, 1.0 or more, or 1.05 or more. Typically, x is 1.5 or less, and may be 1.4 or less, or 1.2 or less.

In the above formula, y represents the molar ratio of O to the total of Ni, Co, and Mn. Typically, y is 1.5 or more, and may be 1.6 or more, 1.7 or more, 1.8 or more, or 1.9 or more. Typically, y is 2.1 or less, and may be 2.0 or less.

In the above formula, a represents the molar ratio of Ni to the total of Ni, Co, and Mn. Typically, a is 0.5 or more, and may be 0.6 or more, 0.7 or more, 0.8 or more, or 0.85 or more. Typically, a is 1.0 or less, and may be 0.9 or less.

In the above formula, b represents the molar ratio of Co to the total of Ni, Co, and Mn. Typically, b is 0 or more, and may be 0.01 or more, 0.02 or more, 0.03 or more, 0.04 or more, 0.05 or more, 0.06 or more, 0.07 or more, or 0.075 or more. Typically, b is 0.30 or less, and may be 0.25 or less, 0.20 or less, 0.15 or less, 0.10 or less, 0.09 or less, or 0.08 or less.

In the above formula, c represents the molar ratio of Mn to the total of Ni, Co, and Mn. Typically, c is 0 or more, and may be 0.01 or more, 0.02 or more, 0.03 or more, 0.04 or more, 0.05 or more, 0.06 or more, 0.07 or more, or 0.075 or more. Typically, c is 0.30 or less, and may be 0.25 or less, 0.20 or less, 0.15 or less, 0.10 or less, 0.09 or less, or 0.08 or less.

In the above formula, the molar ratio a of Ni, the molar ratio b of Co, and the molar ratio c of Mn satisfy the relationship a+b+c=1.0.

The cathode active material in the present disclosure has a composition represented by, for example, LiNi_{0.90}Mn_{0.10}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, or LiNi_{0.9}Co_{0.05}Mn_{0.05}O₂.

In the present disclosure, the composition of the cathode active material can be determined by, for example, dissolving the cathode active material in an acid and measuring the resulting solution using inductively coupled plasma optical emission spectrometry (ICP-OES).

The crystal structure of the primary particles is preferably a layered rock-salt structure. A layered rock-salt crystal structure typically belongs to space group R-3m.

In the present disclosure, as shown in FIGS. 1 and 2, in a cross-sectional scanning electron microscope image of the cathode layer obtained, each of the single-crystal active materials P that are primary particles includes the long edge a and the short edge b, the angle θ between the long edge a and the short edge b is 60° or more and 120° or less, and the aspect ratio, defined as the ratio of the length of the long edge a to the length of the short edge b, is 1.2 or more. The long edge a represents the apparent longest edge of the single-crystal active material P in a cross-sectional SEM image of the cathode layer. The short edge b is connected to an endpoint of the long edge a. The short edge b represents the apparent longest one among the edges connected to the long edge a in a cross-sectional SEM image. The short edge b extends from the endpoint of the long edge a in a direction intersecting the direction in which the long edge a extends. Each of the long edge a and the short edge b may extend linearly. Alternatively, each of the long edge a and the short edge b may be curved. When an edge is curved, the length of the edge is represented by the distance between its endpoints.

In the present disclosure, in a cross-sectional SEM image of the cathode layer, the proportion N_{B}/N_{A} is 20% or more, where N_{A} represents the number of the single-crystal active materials P, and N_{B} represents the number of the single-crystal active materials P in which the direction of the long edge a is inclined at an angle of 50° or more and 90° or less with respect to the in-plane direction D_{P} of the cathode layer. In other words, in the present disclosure, 20% or more of the single-crystal active materials P are oriented substantially perpendicular to the in-plane direction Dₚ of the cathode layer.

The specific method for measuring the proportion N_{B}/N_{A} is as follows. First, in a cross-sectional SEM image of the cathode layer, 100 single-crystal active materials P are randomly selected (N_{A}=100) that include a long edge and a short edge, with the angle between the long edge and the short edge being 60° or more and 120° or less, and the aspect ratio, defined as the ratio of the length of the long edge to the length of the short edge, being 1.2 or more. For each of the 100 selected single-crystal active materials P, the inclination angle θ_{D} of the direction of the long edge a with respect to the in-plane direction D_{P} of the cathode layer is measured, as shown in FIG. 2. Among the 100 single-crystal active materials P, the number of single-crystal active materials P having an inclination angle δ_{D} of 50° or more and 90° or less is defined as N_{B}. The proportion N_{B}/N_{A} is thus calculated.

In the present disclosure, the long edge of each single-crystal active material extends along the (003) plane. By setting the proportion N_{B}/N_{A} to 20% or more, the direction in which lithium ions move toward the cathode active material within the cathode layer (the thickness direction D_{T} of the cathode layer) can be made substantially the same as the direction in which lithium ions diffuse within each primary particle (i.e., the (003) plane direction of each single-crystal active material). As a result, diffusion pathways for lithium ions can be efficiently secured, and the rate capability is improved.

The proportion N_{B}/N_{A} may be 28% or more, or 36% or more. The proportion N_{B}/N_{A} is, for example, 90% or less, and may be 80% or less, 70% or less, 60% or less, or 50% or less.

The proportion N_{C}/N_{A} is, for example, 10% or more, and may be 20% or more, 30% or more, 40% or more, or 50% or more, where N_{A} represents the number of the single-crystal active materials, and N_{C} represents the number of the single-crystal active materials in which the direction of the long edge a is inclined at an angle of 0° or more and less than 50° with respect to the in-plane direction of the cathode layer. The proportion (N_{C}/N_{A}) is typically 80% or less, and may be 70% or less, or 60% or less.

The aspect ratio of each single crystal active material is 1.2 or more, and may be 1.3 or more, 1.4 or more, 1.6 or more, 1.8 or more, 2.0 or more, 2.5 or more, 3.0 or more, 3.5 or more, 4.0 or more, 4.5 or more, 5.0 or more, 5.5 or more, 6.0 or more, 6.5 or more, or 7.0 or more. The aspect ratio may be, for example, 10.0 or less, 9.0 or less, or 8.0 or less.

The length of the long edge a of each single-crystal active material is, for example, 0.5 μm or more, and may be 1.0 μm or more, 1.5 μm or more, 2.0 μm or more, 2.5 μm or more, 3.0 μm or more, 3.5 μm or more, or 4.0 μm or more. The length of long edge a is, for example, 6.0 μm or less, and may be 5.0 μm or less.

The length of the short edge b of each single-crystal active material is, for example, 0.2 μm or more, and may be 0.5 μm or more, 0.8 μm or more, 1.0 μm or more, 1.5 μm or more, 1.7 μm or more, or 1.9 μm or more. The length of the short edge b is, for example, 5.0 μm or less, and may be 4.0 μm or less, 3.0 μm or less, or 2.0 μm or less.

The angle (interior angle) 0 between the long edge a and the short edge b of each single-crystal active material is 60° or more and 1200 or less, and may be 700 or more and 1100 or less, or 80° or more and 100° or less.

In the present disclosure, the long edge a extends along the (003) plane. The (003) plane can be identified in a high-angle annular dark-field scanning transmission electron microscopy (HAADF-STEM) image. For example, powder containing the single-crystal active materials is embedded in epoxy resin. A specimen is prepared by thinning the resin-embedded powder into a foil by, for example argon ion milling. Single-crystal active materials are first identified at low magnification. The long edge a of each of the single-crystal active materials is then determined. Subsequently, the single-crystal active materials are observed at high magnification. The (003) plane is thus identified. When the angle between the (003) plane and the long edge a is from 0° to 30°, the long edge a is regarded as extending along the (003) plane. When one or more of 10 single-crystal active materials randomly selected from a STEM image have the long edge a extending along the (003) plane, the powder as a whole is regarded as having the long edge a extending along the (003) plane.

The angle formed between the long edge a of the single-crystal active material and the (003) plane is, for example, 250 or less, and may be 150 or less, 100 or less, 5° or less, 3° or less, or 1° or less. The proportion of the number of single-crystal active materials having the long edge a extending along the (003) plane among 10 single-crystal active materials randomly selected from a STEM image may be, for example, 20% or more, 30% or more, 40% or more, 50% or more, 60% or more, 70% or more, 80% or more, or 90% or more.

The outer shape of each single-crystal active material is, for example, a polyhedron. The outer shape of each single-crystal active material may be, for example, a hexahedron or an octahedron. Alternatively, the outer shape of each single-crystal active material may be a rectangular prism.

The primary particles have, for example, a crystal structure belonging to space group R-3m. The space group to which the crystal structure belongs is identified from an X-ray diffraction (XRD) pattern. The XRD pattern is obtained by powder XRD measurement, and the measurement conditions are as follows.
Analysis method: wide-angle method
Instrument: SmartLab II (manufactured by Rigaku Corporation)
Measurement angle: 10° to 120°
X-ray tube: CuKα
Tube voltage: 45 kV
Tube current: 200 mA
Scan method: continuous scan
Step size: 0.02°
Scan rate: 2°/min
Incident slit (IS): 1/2°
Receiving slit (RS): 20 mm
Detection mode: one-dimensional

In the present disclosure, it is preferable that the single-crystal active materials do not have a coating layer formed on their surfaces. Examples of the coating layer include a carbon coating layer.

The cathode active material of the present disclosure may or may not include polycrystalline active materials (polycrystalline particles) that are secondary particles formed from the above primary particles. The proportion of the single-crystal active materials in the cathode active material is, for example, 50 wt % or more, and may be 60 wt % or more, 70 wt % or more, 80 wt % or more, or 90 wt % or more. The proportion of the single-crystal active materials in the cathode active material is, for example, 100 wt % or less.

The content of the cathode active material in the cathode layer is, for example, 20 wt % or more, and may be 30 wt % or more, 40 wt % or more, 50 wt % or more, 60 wt % or more, or 70 wt % or more. When the content of the cathode active material is too low, sufficient energy density may not be obtained. The content of the cathode active material is, for example, 95 wt % or less, and may be 90 wt % or less, or 80 wt % or less. When the content of the cathode active material is too high, the ionic conductive properties and electronic conductive properties of the cathode layer may relatively decrease. The content of the cathode active material in the cathode layer refers to the content of the cathode active material when the total solids of the cathode layer are taken as 100 wt %.

### (2) Method for Producing Cathode Active Material

The cathode active material of the present disclosure can be produced by performing a step of synthesizing a transition metal hydroxide, a calcination step of subjecting a mixture of the transition metal hydroxide, an Li source, and a molten salt (flux) to heat treatment, and a step of pulverizing the calcined material.

### (a) Transition Metal Hydroxide Synthesis Step

The transition metal hydroxide serves as a precursor of the cathode active material. The transition metal hydroxide may be obtained as a precipitate by crystallization after dissolving a plurality of types of transition metal compounds in a solvent.

The method for synthesizing the transition metal hydroxide is not particularly limited, and examples include the following method. First, a raw material aqueous solution for the transition metal hydroxide is prepared. As an example of a method for preparing the raw material aqueous solution, a water-soluble transition metal compound may be dissolved in water. Examples of transition metal compounds include metal salts such as sulfates and nitrates. Examples of Ni sources include NiSO₄ and Ni(NO₃)₂. Examples of Co sources include CoSO₄, Co(NO₃)₂, and Co(NO₃)₃. Examples of Mn sources include MnSO₄ and Mn(NO₃)₂. The composition of the raw material aqueous solution is adjusted as appropriate in accordance with the target cathode active material.

Next, a certain amount of aqueous NH₃ solution is placed in a reaction vessel, and while stirring the solution with a stirrer etc., the atmosphere inside the reaction vessel is purged with nitrogen to create a non-oxidizing atmosphere. Subsequently, an aqueous sodium hydroxide solution is added to the reaction vessel, and while maintaining the pH in the alkaline range and controlling the temperature, the above raw material aqueous solution is added dropwise to the reaction vessel to form a reaction solution. By adjusting the pH of the reaction solution, a precipitate (crystallized product) of the transition metal hydroxide can be formed.

After completion of the precipitation reaction, pre-calcination is carried out. The conditions for the pre-calcination include, for example, a temperature of 120° C. or more and 220° C. or less, a time of four hours or more and 10 hours or less, and a pressure of 0.2 MPa or more and 1.0 MPa or less.

After the pre-calcination, the product is washed with water and filtered to collect the transition metal hydroxide, and the collected transition metal hydroxide is subjected to drying. The drying temperature is, for example, 100° C. or more and 150° C. or less. The drying time is, for example, eight hours or more and 24 hours or less.

### (b) Calcination Step

The obtained transition metal hydroxide, an Li source, and a molten salt are mixed to prepare a mixture. The Li source is a lithium compound, and examples include at least one selected from lithium carbonate, lithium nitrate, lithium acetate, lithium hydroxide, lithium oxide, and lithium chloride. The molar ratio of Li contained in the Li source to the transition metal contained in the transition metal hydroxide is, for example, 0.8 or more and 1.2 or less, and may be 0.9 or more and 1.1 or less, or may be 1.0.

The above mixture typically contains a molten salt. The presence of the molten salt in the mixture allows sufficient grain growth of the primary particles. The molar ratio of Li contained in the molten salt to the transition metal contained in the transition metal hydroxide is typically 0.1 or more and 1.0 or less, and may be 0.2 or more and 0.6 or less. The molten salt may be the same type of lithium compound as the Li source. The molten salt is, for example, lithium hydroxide. When lithium hydroxide is used as the Li source, lithium hydroxide is added to the transition metal hydroxide in an amount exceeding the stoichiometric ratio of the target cathode active material. As a result, the lithium hydroxide functions as a flux, allowing sufficient grain growth of the primary particles. The molar ratio of Li contained in the Li source and the molten salt to the transition metal contained in the transition metal hydroxide is, for example, 1.1 or more and 2.0 or less, and may be 1.2 or more and 1.6 or less. The transition metal hydroxide, the Li source, and the molten salt may be mixed by any method. For example, they may be mixed using a mortar.

In the present disclosure, the mixture containing the transition metal hydroxide, the Li source, and the molten salt is subjected to heat treatment. The calcination temperature is, for example, 500° C. or more and 1100° C. or less, and may be 650° C. or more and 1100° C. or less, or 700° C. or more and 900° C. or less. In the present disclosure, it is preferable to perform multistage calcination in which the mixture containing the transition metal hydroxide, the Li source, and the molten salt is calcined at multiple temperatures. This facilitates the formation of single-crystal active materials having the specific shape described above. For example, it is preferable to first calcine the mixture at a predetermined calcination temperature T1 for a predetermined period of time, then increase the temperature to a calcination temperature T2 for the subsequent calcination stage, and continue the calcination at the calcination temperature T2 for a predetermined period of time. The calcination temperature T1 is, for example, 500° C. or more and 650° C. or less, and may be 500° C. or more and 600° C. or less. The calcination temperature T2 is higher than the calcination temperature T1. The calcination temperature T2 is, for example, 650° C. or more and 1100° C. or less, and may be 750° C. or more and 1000° C. or less. The calcination may be performed in two stages, three stages, or four or more stages. The total calcination time across all the stages is, for example, five hours or more and 18 hours or less, and may be eight hours or more and 15 hours or less.

When multistage calcination is performed, additional molten salt may be added to the mixture such that the Li/transition metal (molar ratio) in the mixture increases with each calcination stage. For example, after a mixture containing a transition metal hydroxide and an Li source is calcined at the predetermined calcination temperature T1 for a predetermined period of time, additional molten salt is added, and the temperature is then increased to the calcination temperature T2 for the subsequent calcination stage. Thereafter, the calcination is continued at the calcination temperature T2 for a predetermined period of time. The molten salt may be added such that, by the final calcination stage, the molar ratio of Li contained in the Li source and the molten salt to the transition metal contained in the transition metal hydroxide falls within the range mentioned above. Any type of heat treatment furnace may be used for the calcination, such as a muffle furnace or an electric furnace.

Next, the calcined material is pulverized to a predetermined particle size, for example, to an average particle size of 0.2 μm or less. The pulverization may be performed using an agate mortar. The resulting pulverized material is then dispersed in pure water and washed by stirring. The washed slurry is filtered, rinsed, and vacuum-dried.

The resulting dried powder may be subjected to post-annealing (re-calcination). The post-annealing is performed in an oxygen atmosphere. In the post-annealing, the calcination temperature is, for example, 500° C. or more and 800° C. or less, and the calcination time is, for example, one hour or more and five hours or less.

### (c) Pulverization Step

Subsequently, the calcined material is pulverized and disaggregated to a predetermined particle size. The disaggregation may be performed using an agate mortar. Alternatively, a mill such as a laboratory mill may be used. After the disaggregation, classification or particle size refinement may further be performed. A cathode active material having a predetermined composition and including single-crystal active materials is obtained in this manner.

### 2. Cathode Layer

The cathode layer contains the cathode active material described above, and may further contain, for example, an electrically conductive material and a binder, as needed. The cathode layer may also contain an electrolyte. The electrolyte may be, for example, an electrolyte solution described later. Alternatively, the cathode layer may contain a solid electrolyte.

Examples of the electrically conductive material include graphite, acetylene black (AB), Ketjenblack (registered trademark), vapor-grown carbon fibers (VGCFs), carbon nanotubes (CNTs), and graphene flakes (GFs). The content of the electrically conductive material in the cathode layer may be, for example, 0.1 parts by weight or more and 10 parts by weight or less per 100 parts by weight of the cathode active material.

Examples of the binder include polyvinylidene fluoride (PVdF), vinylidene fluoride-hexafluoropropylene copolymer (PVdF-HFP), polytetrafluoroethylene (PTFE), carboxymethyl cellulose (CMC), polyacrylic acid (PAA), polyvinyl alcohol (PVA), polyvinylpyrrolidone (PVP), polyoxyethylene alkyl ether, and derivatives thereof. The content of the binder in the cathode layer may be, for example, 0.1 parts by weight or more and 10 parts by weight or less per 100 parts by weight of the cathode active material.

The thickness of the cathode layer is, for example, 0.1 μm or more and 1000 μm or less, and may be 1 μm or more and 500 μm or less, or 30 μm or more and 100 μm or less.

The cathode layer can be formed, for example, by the method described in section “C. Method for Manufacturing Cathode Layer.”

In the cross-sectional SEM image of the cathode layer of the present disclosure, single-crystal active materials that are not observed in the specific shape described above may also be present. Such single-crystal active materials include particles having substantially the same outer shape as the single-crystal active materials observed in the specific shape, but appearing as smaller particles or dots because the active material particles are cut at their edges when exposing a cross section of the cathode layer.

### B. Lithium-Ion Battery

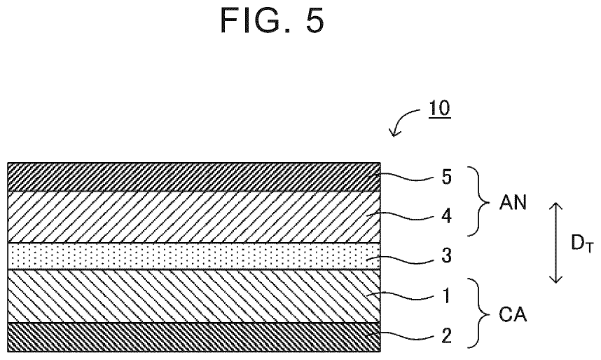

The lithium ion battery of the present disclosure includes the cathode layer described above for use in a lithium-ion battery. That is, the present disclosure provides a battery in which a cathode layer, an electrolyte layer, and an anode layer are stacked in this order, and the cathode layer is the cathode layer described above. FIG. 5 is a schematic sectional view illustrating the lithium-ion battery of the present disclosure. As shown in FIG. 5, a lithium-ion battery 10 includes an anode current collector 5, an anode layer 4, an electrolyte layer 3, a cathode layer 1, and a cathode current collector 2 in this order along the thickness direction D_{T}. The anode current collector 5 and the anode layer 4 constitute an anode AN, and the cathode layer 1 and the cathode current collector 2 constitute a cathode CA.

In the present disclosure, since the lithium-ion battery includes the cathode layer described above, the lithium-ion battery exhibits excellent rate capability.

### 1. Cathode Layer

The cathode layer is the same as that described in section “A. Cathode Layer.”

### 2. Anode Layer

The anode layer contains at least an anode active material and may further contain at least one of the following as needed: an electrolyte, an electrically conductive material, and a binder. Examples of the anode active material include Si and Si alloys, tin and tin alloys, silicon-based active materials such as silicon oxide, carbon-based active materials such as graphite and hard carbon, oxide-based active materials such as lithium titanate, and metallic lithium and lithium alloys.

The anode active material may be, for example, in the form of particles or a sheet. The average particle size of the anode active material particles may be 1 μm or more. The average particle size of the anode active material particles may be, for example, 30 m or less.

The electrically conductive material, binder, and electrolyte used in the anode layer may be the same as those described above for the cathode layer.

### 3. Electrolyte Layer

The electrolyte layer is formed between the cathode layer and the anode layer, and contains at least an electrolyte. The electrolyte is, for example, a liquid electrolyte (electrolyte solution).

An example of the electrolyte solution is a nonaqueous electrolyte solution. The nonaqueous electrolyte solution contains, for example, a lithium salt and a nonaqueous solvent. Examples of lithium salts include inorganic lithium salts such as LiPF₆, LiBF₄, LiClO₄, and LiAsF₆, and organic lithium salts such as LiCF₃SO₃, LiN(SO₂CF₃)₂, LiN(SO₂C₂F₅)₂, and LiC(SO₂CF₃)₃.

Examples of nonaqueous solvents include carbonate-based solvents such as ethylene carbonate (EC), propylene carbonate (PC), butylene carbonate (BC), dimethyl carbonate (DMC), diethyl carbonate (DEC), and ethyl methyl carbonate (EMC). The nonaqueous solvent may be a mixture of a cyclic carbonate having a high dielectric constant and high viscosity, such as EC or PC, and a chain carbonate having a low dielectric constant and low viscosity, such as DMC, DEC, or EMC. The concentration of the lithium salt in the nonaqueous electrolyte solution is, for example, 0.3 M or more and 5 M or less. The nonaqueous electrolyte solution may contain an ionic liquid. Examples of ionic liquids include sulfonium salts, ammonium salts, pyridinium salts, piperidinium salts, pyrrolidinium salts, morpholinium salts, phosphonium salts, and imidazolium salts.

Another example of the electrolyte solution is an aqueous electrolyte solution. An aqueous electrolyte solution contains water as a main component of the solvent. The proportion of water to the total solvent is, for example, 50 mass % or more, and may be 70 mass % or more. Examples of lithium salts used in the aqueous electrolyte solution include imide-based electrolytes such as lithium bis(fluorosulfonyl)imide and lithium bis(trifluoromethanesulfonyl)imide. The concentration of the lithium salt in the aqueous electrolyte solution is, for example, 1 M or more and 25 M or less.

The electrolyte layer may include a separator impregnated with the electrolyte solution described above. Providing the separator can suppress the occurrence of internal short-circuits. The separator is, for example, a porous membrane. Examples of materials for the separator include resins such as polyethylene, polypropylene, polyester, polyvinyl alcohol, cellulose, and polyamide. The electrolyte layer may contain a solid electrolyte. Examples of the solid electrolyte include organic electrolytes such as polymer electrolytes and gel electrolytes, and inorganic solid electrolytes such as sulfide solid electrolytes, oxide solid electrolytes, and halide solid electrolytes.

### 4. Cathode Current Collector

Examples of materials for the cathode current collector include SUS, Cr, Au, Pt, Zn, aluminum, copper, nickel, iron, titanium, and carbon. The thickness of the cathode current collector is, for example, 0.1 μm or more and 100 μm or less. The cathode current collector may be in the form of, for example, a foil, a mesh, or a porous structure. The shape of the cathode current collector as viewed in plan is not particularly limited, and examples include circular, elliptical, rectangular, and any polygonal shapes. The cathode current collector may have a configuration in which a buffer layer, an elastic layer, or a positive temperature coefficient (PTC) thermistor layer is provided on its surface.

### 5. Anode Current Collector

Examples of materials for the anode current collector include SUS, aluminum, copper, nickel, iron, titanium, and carbon. The thickness of the anode current collector varies depending on its shape, and is, for example, 1 μm or more and 50 μm or less. The anode current collector may be in the form of, for example, a foil or a plate. The shape of the anode current collector as viewed in plan is not particularly limited, and examples include circular, elliptical, rectangular, and any polygonal shapes. The anode current collector may have a configuration in which a buffer layer, an elastic layer, or a PTC thermistor layer is provided on its surface.

### 6. Lithium-Ion Battery

The battery of the present disclosure may include an outer casing that houses a power generation element (a cathode layer, an electrolyte layer, and an anode layer). Examples of the outer casing include a case-type outer casing and a laminate-type outer casing.

The lithium-ion battery of the present disclosure is typically a secondary battery. When a set of a cathode layer, an electrolyte layer, and an anode layer constitutes a power generation unit, the lithium-ion battery of the present disclosure may be a single cell having one power generation unit or a stacked battery having two or more power generation units. The stacked battery may be a monopolar stacked battery (parallel-connected stacked battery) or a bipolar stacked battery (series-connected stacked battery).

The applications of the lithium-ion battery are not particularly limited, but examples include power sources for vehicles such as hybrid electric vehicles (HEVs), plug-in hybrid electric vehicles (PHEVs), battery electric vehicles (BEVs), gasoline vehicles, and diesel vehicles. In particular, the lithium-ion battery is preferably used as a traction power source for a hybrid electric vehicle (HEV), a plug-in hybrid electric vehicle (PHEV), or a battery electric vehicle (BEV). The battery may also be used as a power source for moving objects other than vehicles (for example, trains, ships, and aircraft), or as a power source for electrical products such as information processing devices.

### C. Method for Manufacturing Cathode Layer

The method for manufacturing a cathode layer according to the present disclosure is a method for manufacturing the cathode layer described above, and includes: a coating step of obtaining a cathode layer precursor by applying a cathode slurry containing a solvent and the cathode active material including the single-crystal active materials; and an orientation step of orienting the single-crystal active materials such that the directions of their long edges are inclined at an angle of 500 or more and 90° or less with respect to the in-plane direction of the cathode layer, by exposing the cathode layer precursor to a magnetic field.

In the present disclosure, the single-crystal active materials can be easily oriented such that their long edges are inclined substantially perpendicularly (i.e., at an angle of 50° or more and 90° or less) to the in-plane direction of the cathode layer.

### 1. Coating Step

In this step, for example, a cathode slurry is obtained by mixing the cathode active material including the single-crystal active materials with a solvent, and the cathode slurry is applied onto a cathode current collector to form, on the cathode current collector, a coating layer serving as a cathode layer precursor. The single-crystal active materials and the cathode active material are the same as those described in section “1. Cathode Active Material” of “A. Cathode Layer.”

Examples of the solvent include N-methylpyrrolidone (NMP), tetralin, diisobutyl ketone, butyl butyrate, mesitylene, heptane, dibutyl ether, decane, dodecane, isodecane, and toluene.

### 2. Orientation Step

In this step, the cathode layer precursor is exposed to a magnetic field to orient the single-crystal active materials such that the direction of their long edges are inclined at an angle of 50° or more and 90° or less with respect to the in-plane direction of the cathode layer. FIG. 4 is a schematic diagram illustrating application of a magnetic field in this step. As shown in FIG. 4, for example, a structure 20 including a cathode current collector 2 and a cathode layer precursor 1′ is obtained by applying a slurry containing the single-crystal active materials P onto the cathode current collector 2 in the coating step. Subsequently, an S-pole 30a and an N-pole 30b of neodymium magnets are fixed to the left and right side surfaces of the structure 20, and the structure 20 is exposed to a magnetic field. The directions of the long edges of the single-crystal active materials P can thus be adjusted to be substantially perpendicular to the in-plane direction of the cathode layer (the in-plane direction of the current collector). The intensity of the magnetic field is, for example, five tesla or more and 10 tesla or less. The duration of exposure to the magnetic field is, for example, one minute or more and two hours or less, and may be one minute or more and one hour or less, or three minutes or more and one hour or less. When drying and pressing are performed without carrying out the orientation step, the proportion N_{B}/N_{A} described above is usually less than 20%.

After the orientation step, drying and pressing may be performed as needed. Examples of the pressing include roll pressing and flat plate pressing. The cathode layer can thus be manufactured.

The present disclosure is not limited to the above embodiment. The above embodiment is merely illustrative, and any structure having substantially the same configuration as, and having similar functions and effects to, the technical idea described in the claims of the present disclosure is included in the technical scope of the present disclosure.

### Example 1

### Synthesis of Cathode Active Material

A cathode active material having a composition represented by LiNi_{0.90}Mn_{0.10}O₂ was obtained by the following method.

### Preparation of Raw Material Aqueous Solution

First, NiSO₄ and MnSO₄ were dissolved in deionized water to prepare a raw material aqueous solution. The mixing ratio of NiSO₄ and MnSO₄ was adjusted such that the Ni/Mn ratio was 90/10 atm %. The concentration of the raw material aqueous solution (the number of moles of the raw materials (total solutes) relative to the raw material aqueous solution) was set to 0.2 mol %.

### Dehydration and Pre-Calcination

A predetermined amount of aqueous NH₃ solution was placed in a reaction vessel, and the atmosphere inside the reaction vessel was purged with nitrogen while stirring the solution with a stirrer. NaOH was added to the reaction vessel to adjust the pH of the solution to an alkaline level. While keeping the pH of the solution in the reaction vessel constant and controlling the temperature, the raw material aqueous solution was added dropwise to precipitate a transition metal hydroxide. After completion of the precipitation reaction, the precipitate was subjected to dehydration and pre-calcination under the following temperature and pressure conditions.
Temperature: 120° C.
Time: eight hours
Pressure: 1.0 MPa

### Recovery of Precursor

After the pre-calcination, the precipitate was washed with water. The washed precipitate was filtered to collect the transition metal hydroxide. The collected transition metal hydroxide was then dried at 110° C. for 12 hours to evaporate moisture (to obtain a dried material). A precursor was thus prepared.

### Mixing of Li Raw Material and Molten Salt

The obtained precursor (transition metal hydroxide) and LiOH as an Li source were mixed using a mortar. The LiOH as the Li source was mixed such that the proportion (molar ratio) of Li contained in the Li source to the total amount of transition metal species (Ni and Mn) contained in the transition metal hydroxide was 1.0. Furthermore, LiOH as a molten salt was mixed such that the proportion (molar ratio) of Li contained in the molten salt to the total amount of transition metal species contained in the transition metal hydroxide was 0.2. That is, the total amount of LiOH was adjusted such that the proportion (molar ratio) of Li contained in the LiOH to the total amount of transition metal species contained in the transition metal hydroxide was 1.2. Accordingly, the excess lithium compound forms a molten salt during calcination, thereby promoting single crystallization of the cathode active material.

### Calcination

The mixture was subjected to heat treatment (calcination). Specifically, the mixture was first calcined at 500° C. for three hours in a muffle furnace, and then at 780° C. for 12 hours (calcination step). Next, the obtained calcined material was crushed in an agate mortar to a particle size of 0.2 mm or less, dispersed in 500 mL of pure water, and vigorously stirred for one minute to obtain a slurry. The slurry was filtered using a Buchner funnel and filter paper and rinsed with 500 mL of pure water, and the resulting cake was vacuum-dried at 90° C. After drying, the obtained dried powder was calcined again at 500° C. for three hours under an oxygen flow (re-calcination). The calcined material was pulverized in an agate mortar and disaggregated to a predetermined particle size (pulverization). As a result, particles having a composition represented by LiNi_{0.90}Mn_{0.10}O₂ were obtained.

### Fabrication of Cathode

A cathode slurry containing the above particles as a cathode active material, acetylene black, and an NMP solvent was applied onto an aluminum foil serving as a cathode current collector, using a film applicator with a thickness adjustment function (manufactured by Allgood Co., Ltd.), thereby obtaining a structure having a cathode current collector and a cathode layer precursor (coating step). Neodymium magnets were fixed to the left and right side surfaces of the structure, and the structure was exposed to a magnetic field of about five tesla for one hour (orientation step). After exposure to the magnetic field, the structure was subjected to drying on a hot plate at 80° C. for five minutes to evaporate the NMP solvent, followed by pressing (three passes using a 3-ton roll press). A cathode having a cathode current collector (aluminum foil) and a cathode layer was thus obtained.

The obtained cathode was cut in the thickness direction by ion milling to expose a cross section of the cathode layer. The cross section of the cathode layer was observed with a scanning electron microscope (SU8230, manufactured by Hitachi High-Tech Corporation) at an acceleration voltage of 1 kV. In the cross-sectional SEM image, single-crystal active materials that were crystalline primary particles were observed. One hundred single-crystal active materials (N_{A}=100) were randomly selected, each having two discernible edges, namely a short edge and a long edge, with the angle between the short and long edges being 60° or more and 120° or less, and the aspect ratio, defined as the ratio of the length of the long edge to the length of the short edge, being 1.2 or more. Among the 100 single-crystal active materials, the number N_{B} of primary particles in which the direction of the long edge was inclined at an angle of 50° or more and 90° or less with respect to the in-plane direction of the cathode layer (the in-plane direction of the metal foil) was counted. The proportion (N_{B}/N_{A}) of the number N_{B} to the number N_{A} was calculated. The results are shown in Table 1.

### Fabrication of Battery

A metallic lithium foil was prepared as the anode. A 1 M LiPF₆ solution containing LiPF₆ as an electrolyte and ethylene carbonate (EC), dimethyl carbonate (DMC), and ethyl methyl carbonate (EMC) as solvents in a volume ratio of EC/DMC/EMC=3/4/3 vol % was prepared as an electrolyte solution. A coin cell having an electrode area of 16 mm in diameter was fabricated using the cathode, the electrolyte solution, and the anode.

### Example 2

Except that a lithium compound (LiOH) was mixed as a molten salt such that the proportion (molar ratio) of Li contained in the molten salt to the total amount of transition metal species contained in the transition metal hydroxide was 0.6, the cathode active material was synthesized in the same manner as in Example 1. That is, the total amount of LiOH was adjusted such that the proportion (molar ratio) of Li contained in the LiOH to the total amount of transition metal species contained in the transition metal hydroxide was 1.6. Using the obtained cathode active material, a cathode was fabricated in the same manner as in Example 1, except that the structure was exposed to a magnetic field for three minutes in the orientation step. A coin cell having the same configuration as in Example 1 was obtained, except that the cathode thus obtained was used.

### Example 3

Except that a lithium compound (LiOH) was mixed as a molten salt such that the proportion (molar ratio) of Li contained in the molten salt to the total amount of transition metal species contained in the transition metal hydroxide was 0.6, the cathode active material was synthesized in the same manner as in Example 1. That is, the total amount of LiOH was adjusted such that the proportion (molar ratio) of Li contained in the LiOH to the total amount of transition metal species contained in the transition metal hydroxide was 1.6. Using the obtained cathode active material, a cathode was fabricated in the same manner as in Example 1, except that the structure was exposed to a magnetic field for one minute in the orientation step. A coin cell having the same configuration as in Example 1 was obtained, except that the cathode thus obtained was used.

### Comparative Example 1

A cathode was fabricated in the same manner as in Example 1, except that the orientation step was not performed. A coin cell having the same configuration as in Example 1 was obtained, except that the cathode thus obtained was used.

### Comparative Example 2

A cathode was fabricated in the same manner as in Example 1, except that, in the orientation step, neodymium magnets were fixed above and below the structure, and the structure was exposed to a magnetic field of about five tesla for 20 seconds. A coin cell having the same configuration as in Example 1 was obtained, except that the cathode thus obtained was used.

### Evaluation

Using the obtained coin cells, a capacity evaluation test was conducted under the following conditions.
Ambient temperature: 25° C.
Current rate: 0.1 C
Voltage range: 4.3 V to 3.0 V

After the initial discharge capacity of each coin cell was measured at 0.1 C, each cell was recharged under constant-current constant-voltage (CC-CV) conditions and then discharged at 1 C. In the initial capacity test, the electrical capacity (mAh) obtained during the discharge process of the first charge-discharge cycle was divided by the weight (in grams) of the cathode active material contained in the electrode of the coin cell to calculate the discharge capacity at 0.1 C per gram of cathode active material (mAh g⁻¹). Similarly, the discharge capacity at 1 C was calculated. Based on these values, the ratio of the discharge capacity at 1 C to the discharge capacity at 0.1 C was determined as the rate capability. The results are shown in Table 1.

TABLE 1

| | | Rate Capability |
|---|---|---|
| | | (1 C Discharge Capacity/ |
| | N_{B}/N_{A} | 0.1 C Discharge Capacity) |
| | (%) | (%) |
| Example 1 | 50 | 92.5 |
| Example 2 | 36 | 92.2 |
| Example 3 | 28 | 89.8 |
| Comparative Example 1 | 19 | 88.5 |
| Comparative Example 2 | 15 | 86.3 |

As shown in Table 1, it was confirmed that the batteries having a cathode layer with N_{B}/N_{A} of 20% or more (Examples 1 to 3) exhibited higher rate capability than the batteries having a cathode layer with N_{B}/N_{A} of less than 20% (Comparative Examples 1 and 2).

What is claimed is:

1. A cathode layer for use in a lithium-ion battery, the cathode layer comprising, as a cathode active material, single-crystal active materials that are primary particles, the primary particles being crystalline and containing Li, a transition metal, and o, wherein
in a cross-sectional scanning electron microscope image of the cathode layer,
each of the single-crystal active materials includes a long edge and a short edge, an angle between the long edge and the short edge is 60° or more and 120° or less, and an aspect ratio, defined as a ratio of a length of the long edge to a length of the short edge, is 1.2 or more,
the long edge of each of the single-crystal active materials extends along a (003) plane, and
a proportion N_{B}/N_{A} is 20% or more, where N_{A} represents the number of the single-crystal active materials, and N_{B} represents the number of the single-crystal active materials in which a direction of the long edge is inclined at an angle of 50° or more and 90° or less with respect to an in-plane direction of the cathode layer.

2. The cathode layer according to claim 1, wherein the length of the long edge of each of the single-crystal active materials is 0.5 μm or more.

3. The cathode layer according to claim 1, wherein the proportion N_{B}/N_{A} is 28% or more and 50% or less.

4. The cathode layer according to claim 1, wherein the primary particles have a composition represented by LiₓNiₐCo_{b}Mn_{c}O_{y} (where 0.1≤x≤1.5, 0.5≤a≤1.0, 0≤b≤0.3, 0≤c≤0.3, a+b+c=1.0, and 1.5≤y≤2.1).

5. A lithium-ion battery comprising the cathode layer according to claim 1.

6. A method for manufacturing the cathode layer according to claim 1, the method comprising:
obtaining a cathode layer precursor by applying a cathode slurry containing the cathode active material including the single-crystal active materials; and
orienting the single-crystal active materials such that the direction of the long edge of each of the single-crystal active materials is inclined at an angle of 50° or more and 90° or less with respect to the in-plane direction of the cathode layer, by exposing the cathode layer precursor to a magnetic field.
